(19) United States
(12) Patent Application Publication
(10) Pub. No.: US 2015/0196116 A1
(43) Pub. Date: Jul. 16, 2015

(54) Apparatus for Adjusting the Height of a Table

(71) Applicant: Ming Yu Ling, TAICHUNG CITY (TW)

(72) Inventor: Ming Yu Ling, TAICHUNG CITY (TW)

(21) Appl. No.: 14/156,416

(22) Filed: Jan. 15, 2014

(51) Int. Cl. A47B 9/04; F16H 1/20

(52) U.S. Cl. CPC A47B 9/04; F16H 1/203; A47B 2009/046

(57) ABSTRACT

A table is provided with a height-adjusting apparatus. The height-adjusting apparatus includes a post, an elevating unit and an operating unit. The post includes an external tube and an internal tube. The internal tube includes a lower end telescopically inserted in the external tube and an upper end for supporting the table. The elevating unit includes a threaded rod and a nut. The threaded rod is connected to the internal tube so that the threaded rod is rotatable but not rectilinearly movable relative to the internal tube. The nut is non-movably connected to the external tube. The nut is engaged with the threaded rod. The operating unit is operable to rotating the threaded rod relative to the nut to rectilinearly move the threaded rod relative to the nut. Thus, the internal tube is rectilinearly movable relative to the external tube.

### BACKGROUND OF INVENTION

1. Field of Invention

The present invention relates to a table and, more particularly, to an apparatus for adjusting the height of a table.

2. Related Prior Art

Conventional tables are made with constant height. A conventional table could be too low for a tall user or too high for a short user. Such a mismatch inevitably entails an improper position of the user. Such an improper position eventually causes health problems such as sore muscles, humpback, scoliosis, or damages to the eyes.

For an adult, he or she can have a table made according to his or her height. Such a table is however expensive.

A child who has a table made according to his or her height now will need a higher table when he or she grows taller. It costs an extra amount of money to purchase another table.

The present invention is therefore intended to obviate or at least alleviate the problems encountered in prior art.

### SUMMARY OF INVENTION

It is the primary objective of the present invention to provide an apparatus for adjusting the height of a table.

To achieve the foregoing objective, the height-adjusting apparatus includes a post, an elevating unit and an operating unit. The post includes an external tube and an internal tube. The internal tube includes a lower end telescopically inserted in the external tube and an upper end for supporting the table. The elevating unit includes a threaded rod and a nut. The threaded rod is connected to the internal tube so that the threaded rod is rotatable but not rectilinearly movable relative to the internal tube. The nut is non-movably connected to the external tube. The nut is engaged with the threaded rod. The operating unit is operable to rotating the threaded rod relative to the nut to rectilinearly move the threaded rod relative to the nut. Thus, the internal tube is rectilinearly movable relative to the external tube.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a table equipped with a height-adjusting apparatus according to the preferred embodiment of the present invention;

FIG. 2 is another perspective view of the table and the height-adjusting apparatus shown in FIG. 1;

FIG. 3 is an exploded view of the height-adjusting apparatus shown in FIG. 1;

FIG. 4 is an enlarged partial view of the height-adjusting apparatus shown in FIG. 3;

FIG. 5 is a cross-sectional view of the table and the height-adjusting apparatus shown in FIG. 1; and

FIG. 6 is an enlarged partial view of the table and the height-adjusting apparatus shown in FIG. 5.

### DETAILED DESCRIPTION OF PREFERRED EMBODIMENT

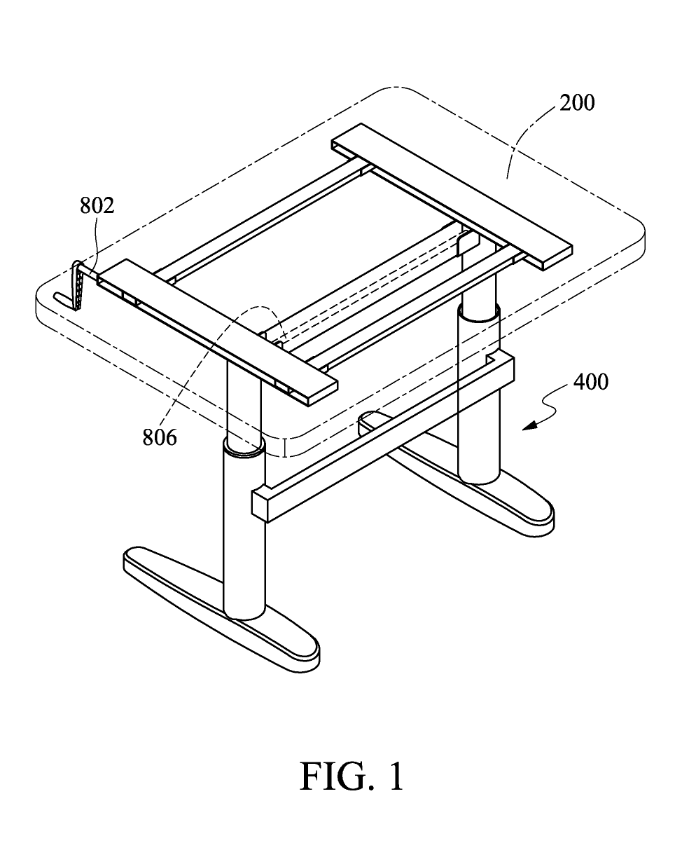

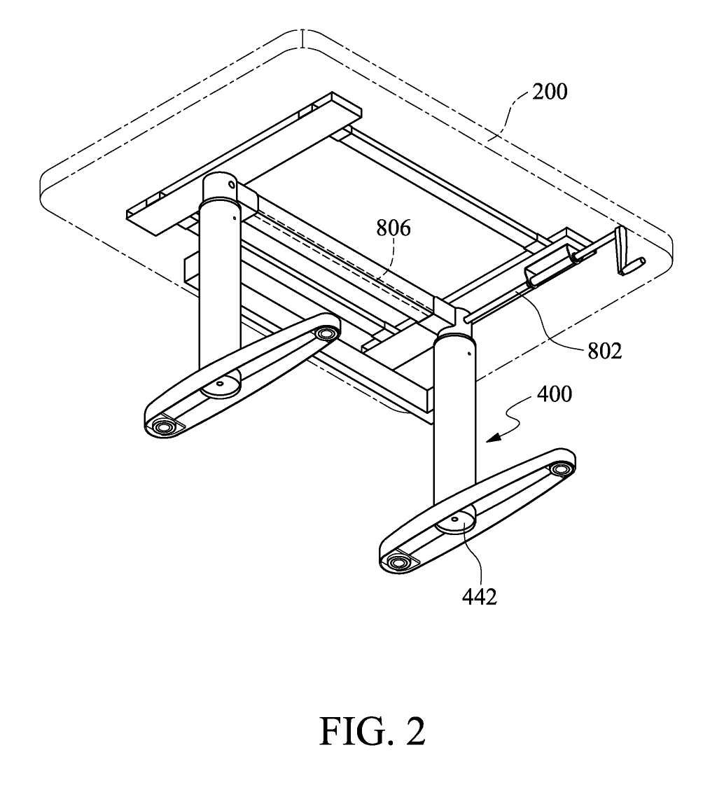

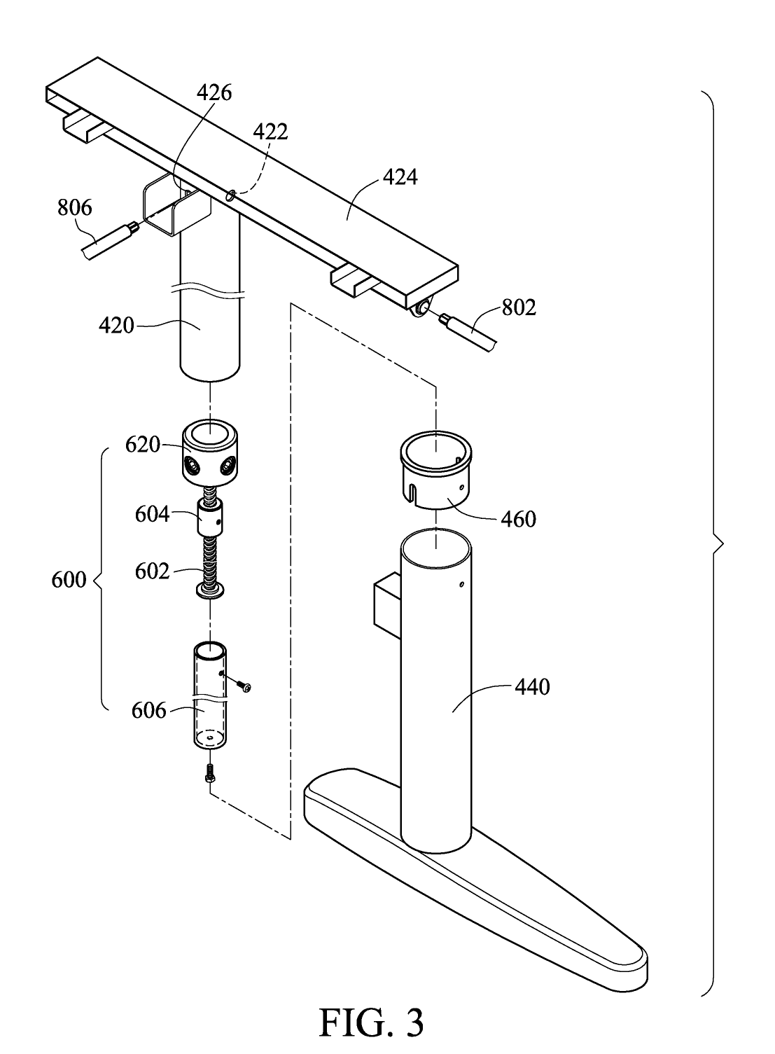

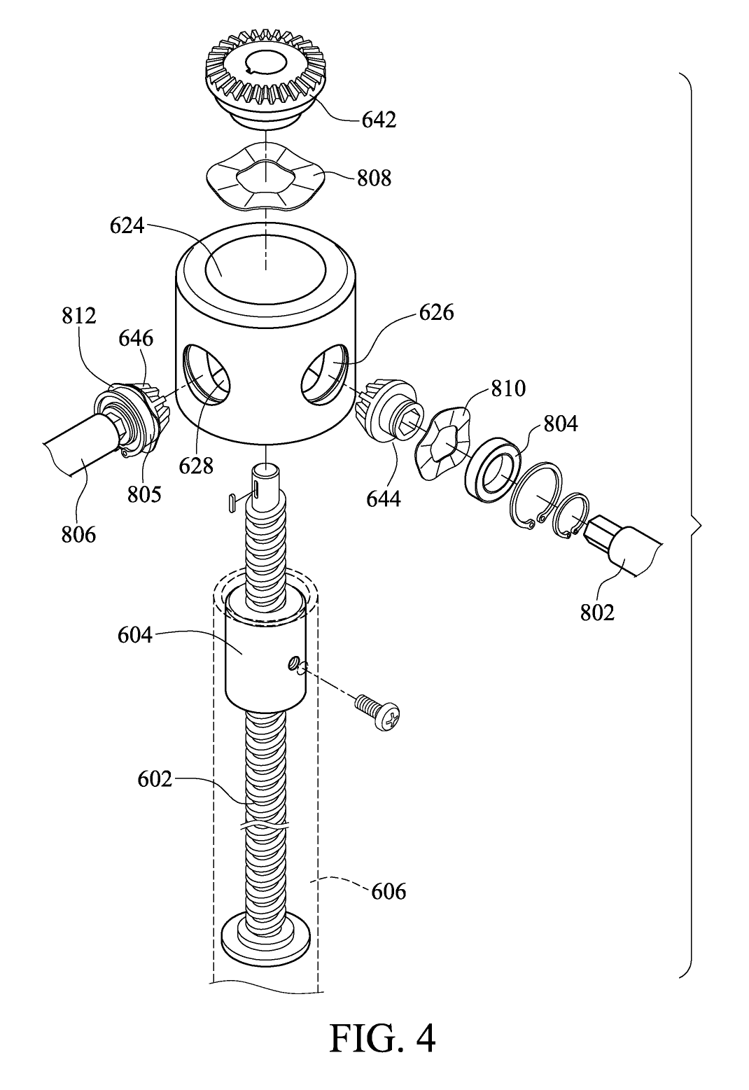

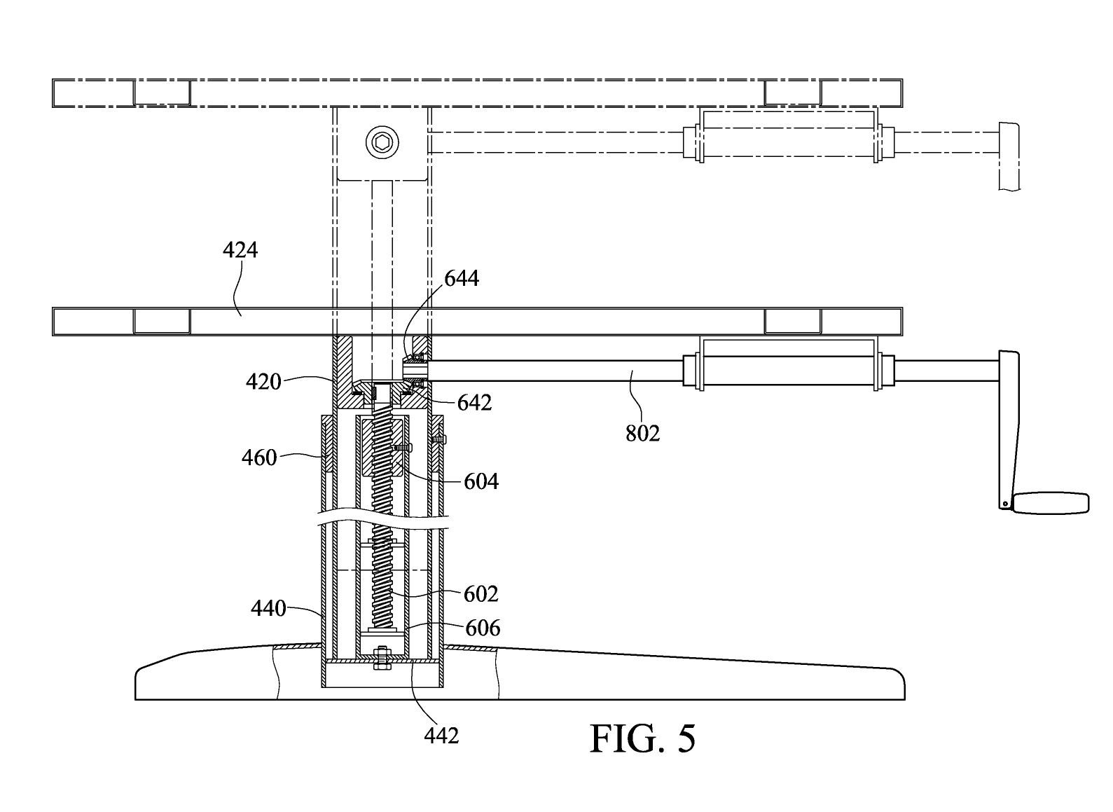

Referring to FIGS. 1 through 6, a table 200 is equipped with a height-adjusting apparatus that includes two posts 400, two elevating units 600 and an operating unit 800 according to the preferred embodiment of the present invention.

For clarity, one of the posts 400 will be referred to as the primary post 400 in the following description while the other post 400 will be referred to as the secondary post 400. The primary post 400 includes an internal tube 420 and an external tube 440. A foot (not numbered) is attached to a lower end of the external tube 440. The internal tube 420 includes a lower end inserted in the external tube 440. A beam 424 is attached to an upper end of the internal tube 420. The table 200 is supported on the beam 424. The internal tube 420 is made with two apertures 422 and 426 that are about 90° away from each other.

The secondary post 400 is like the primary post 400 except that the internal tube 420 does not include the aperture 422. The aperture 426 of the internal tube 420 of the secondary post 400 is aligned with the aperture 426 of the internal tube 420 of the primary post 400.

For clarity, one of the elevating units 600 will be referred to as the primary elevating unit 600 in the following description while the other elevating unit 600 will be referred to as the secondary elevating unit 600. The primary elevating unit 600 is inserted in the primary post 400 while the secondary elevating unit 600 is inserted in the secondary post 400.

The primary elevating unit 600 includes a threaded rod 602, a nut 604, a sleeve 606, a cage 620 and three gears 642, 644 and 646. The sleeve 606 is inserted in the primary post 400. The sleeve 606 includes a lower end attached to the disc 442. The nut 604 is placed in and attached to the sleeve 606 near an upper end. The threaded rod 602 is engaged with the nut 604.

The cage 620 includes a cavity 622, an axial aperture 624 and two radial apertures 626 and 628. The cavity 622 is in communication with all of the apertures 624, 626 and 628. The cage 620 is placed in and attached to the internal tube 420 so that the radial apertures 626 and 628 are respectively aligned with the apertures 422 and 426.

The bevel gears 642, 644 and 646 are placed in the cavity 622. The bevel gear 642 includes a shank inserted in the axial aperture 624. The bevel gear 644 includes a shank supported by a bearing 804 that is placed in the radial aperture 626. The bevel gear 646 includes a shank supported by a bearing 805 that is placed in the radial aperture 628.

The secondary elevating unit 600 is like the primary elevating unit 600 except several things. At first, the bevel gear 644 is omitted, and so are the bearing 804 and the wave washer 810. Secondly, the cage 620 does not include the radial aperture 626.

The operating unit 800 includes a shaft 802 and an axle 806. The shaft 802 includes an end connected to a crank (not numbered) and another end connected to the shank of the bevel gear 644. The axle 806 includes two ends each connected to the shank of the bevel gear 646 of a corresponding elevating unit 600. An upper end of the threaded rod 602 is connected to the shank of the bevel gear 642.

Preferably, a wave washer 808 is placed between the bevel gear 642 and the cage 620 to prevent the shank of the bevel gear 642 from sliding in the axial aperture 624. Another wave washer 810 is placed between the bevel gear 644 and the cage 620 to prevent the shank of the bevel gear 644 from sliding in the radial aperture 626. Another wave washer 812 is placed between the bevel gear 646 and the cage 620 to prevent the shank of the bevel gear 646 from sliding in the radial aperture 628.

In use, the crank is operated to rotate the shaft 802. The shaft 802 rotates the bevel gear 644 of the primary elevating unit 600. In the primary elevating unit 600, the bevel gear 644 rotates the bevel gear 642, which in turn rotates the bevel gear 646. The bevel gear 646 of the primary elevating unit 600 rotates the axle 806. The axle 806 rotates the bevel gear 646 of the secondary elevating unit 600. In the secondary elevating unit 600, the bevel gear 646 rotates the bevel gear 642. In each elevating unit 600, the bevel gear 642 rotates the threaded rod 602. The threaded rod 602 is rectilinearly moved relative to the nut 604 since the threaded rod 602 is engaged with the nut 604, which is kept in position because it is non-movably attached to the sleeve 606, which is in turn non-movably attached to the disc 442, which is non-movably attached to the external tube 440. The external tube 440 is non-movably attached to the foot. The foot is place on the ground or a floor. Hence, the threaded rod 602 is rectilinearly relative to the ground or floor. Accordingly, cage 620 is rectilinearly moved relative to the ground or floor. Therefore, the internal tube 420 is rectilinearly moved relative to the ground or floor. That is, the table 200 is lifted or lowered relative to the ground or floor.

The height-adjusting apparatus can include only one post 400 and one elevating unit 600 in an alternative embodiment. The operating unit 800 of such an alternative embodiment is like the operating unit 800 of the preferred embodiment except omitting the axle 806. The elevating unit 600 of such an alternative embodiment is like the primary elevating unit 600 of the preferred embodiment except several things. At first, the bevel gear 646 is omitted, and so are the bearing 805 and the wave washer 812. Secondly, the cage 620 does not include the radial aperture 628. The post 400 of such an alternative embodiment is like the primary post 400 of the preferred embodiment except that the internal tube 420 does not include the aperture 426.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A height-adjusting apparatus including:
a post 400 including an external tube 440 and an internal tube 420 formed with a lower end telescopically inserted in the external tube 440 and an upper end for supporting a table 200;
an elevating unit 600 including a nut 604 non-movably connected to the external tube 440 and a threaded rod 602 engaged with the nut 604 and connected to the internal tube 420 so that the threaded rod 602 is rotatable but not rectilinearly movable relative to the internal tube 420; and
an operating unit 800 operable to rotating the threaded rod 602 relative to the nut 604 to rectilinearly move the threaded rod 602 relative to the nut 604 so that the internal tube 420 is rectilinearly movable relative to the external tube 440.

2. The height-adjusting apparatus according to claim 1, wherein the elevating unit 600 includes a sleeve 606 placed in and non-movably connected to the external tube 440, and wherein the nut 604 is placed in and non-movably connected to the sleeve 606 near an upper end.

3. The height-adjusting apparatus according to claim 2, and wherein the post 400 includes a disc 442 non-movably connected to the external tube 440 near a lower end, and wherein the sleeve 606 includes a lower end non-movably connected to the disc 442.

4. The height-adjusting apparatus according to claim 1, wherein the operating unit 800 includes a crank shaft 802 operatively connected to the threaded rod 602.

5. The height-adjusting apparatus according to claim 4, wherein the elevating unit 400 includes a beam 424 connected to an upper end of the internal tube 420 of the primary post 400, and wherein the crank shaft 802 is covered by the beam 424.

6. The height-adjusting apparatus according to claim 4, wherein the operating unit 800 includes a first bevel gear 644 connected to the crank shaft 802 and a second bevel gear 642 connected to the threaded rod 602 and engaged with the first bevel gear 644.

7. The height-adjusting apparatus according to claim 6, wherein the operating unit 800 includes a cage 620 non-movably connected to the internal tube 420 near an upper end, and wherein the cage 620 includes a radial aperture 626 for receiving a portion of the first bevel gear 644 and an axial aperture 624 for receiving a portion of the second bevel gear 642.

8. The height-adjusting apparatus according to claim 7, and wherein the operating unit 800 includes a wave washer 810 sandwiched between a portion of the first bevel gear 644 and a portion of the cage 622.

9. The height-adjusting apparatus according to claim 7, and wherein the operating unit 800 includes a bearing 804 for supporting the first bevel gear 644 in the radial aperture 626.

10. The height-adjusting apparatus according to claim 7, wherein the operating unit 800 includes a wave washer 808 sandwiched between a portion of the second bevel gear 642 and a portion of the cage 622.

11. The height-adjusting apparatus according to claim 7, wherein the internal tube 420 includes an aperture 422 for receiving the crank shaft 802.

12. A height-adjusting apparatus including:
a primary post 400 and a secondary post 400, wherein each of the posts 400 includes an external tube 440 and an internal tube 420 formed with a lower end telescopically inserted in the external tube 440 and an upper end for supporting a table 200;
a primary elevating unit 600 and a secondary elevating unit 600, wherein each of the elevating units 600 includes a nut 604 non-movably connected to the external tube 440 of the corresponding one of the posts 400 and a threaded rod 602 engaged with the nut 604 and connected to the internal tube 420 of the corresponding one of the posts 400 so that the threaded rod 602 is rotatable but not rectilinearly movable relative to the internal tube 420; and
an operating unit 800 operable to rotating the threaded rod 602 of each of the elevating units 600 relative to the nut 604 to rectilinearly move the threaded rod 602 relative to the nut 604 so that the internal tube 420 of the corresponding post 400 is rectilinearly movable relative to the external tube 440.

13. The height-adjusting apparatus according to claim 12, wherein each of the elevating units 600 includes a sleeve 606 placed in and non-movably connected to the external tube 440, and wherein the nut 604 is placed in and non-movably connected to the sleeve 606 near an upper end.

14. The height-adjusting apparatus according to claim 13, wherein each of the posts 400 includes a disc 442 non-movably connected to the external tube 440 near a lower end, and wherein the sleeve 606 includes a lower end non-movably connected to the disc 442.

15. The height-adjusting apparatus according to claim 12, wherein the operating unit 800 includes a crank shaft 802 operatively connected to the threaded rod 602 of the primary elevating unit 600 and an axle for connecting the threaded rod 602 of the primary elevating unit 600 to the threaded rod 602 of the secondary elevating unit 600.

16. The height-adjusting apparatus according to claim 15, wherein the primary elevating unit 400 includes a beam 424 connected to an upper end of the internal tube 420 of the primary post 400, and wherein the crank shaft 802 is covered by the beam 424, and wherein the table 200 is supported on the beam 424.

17. The height-adjusting apparatus according to claim 16, wherein the operating unit 800 includes a first bevel gear 644 connected to the crank shaft 802, a second bevel gear 642 engaged with the first bevel gear 644 and connected to the threaded rod 602 of the primary elevating unit 600, a third bevel gear 646 engaged with the second bevel gear 642 and non-movably connected to an end of the axle 806, a forth bevel gear 646 non-movably connected to another end of the axle 806, and a fifth bevel gear 642 engaged with the fourth bevel gear 642 and non-movably connected to the threaded rod 602 of the secondary elevating unit 600.

18. The height-adjusting apparatus according to claim 17, wherein the operating unit 800 includes:
a primary cage 620 non-movably connected to the internal tube 420 of the primary post 400 near an upper end, wherein the primary cage 620 includes a radial aperture 626 for receiving a portion of the first bevel gear 644, an axial aperture 624 for receiving a portion of the second bevel gear 642, an another radial aperture 628 for receiving a portion of the third bevel gear 646; and
a secondary cage 620 non-movably connected to the internal tube 420 of the secondary post 400 near an upper end, wherein the secondary cage 620 includes a radial aperture 626 for receiving a portion of the fourth bevel gear 644 and an axial aperture 624 for receiving a portion of the fifth bevel gear 642.

19. The height-adjusting apparatus according to claim 18, wherein the operating unit 800 includes a wave washer 808 sandwiched between a portion of each of the bevel gears 642 and a portion of the corresponding cage 622.

20. The height-adjusting apparatus according to claim 18, wherein the operating unit 800 includes a bearing for supporting each of the bevel gears in the correspond aperture of the corresponding cage.
